(19) United States
(12) Patent Application Publication
(10) Pub. No.: US 2008/0068495 A1
(43) Pub. Date: Mar. 20, 2008

(54) Imajector

(76) Inventor: Gwenne Siron Bacani, Daly City, CA (US)

Correspondence Address: GWENNE BACANI, 64 WOODROW STREET, DALY CITY, CA, 94014, US

(21) Appl. No.: 11/474,421

(22) Filed: Sep. 19, 2006

(51) Int. Cl. H04N 5/225

(52) U.S. Cl. 348/375

(57) ABSTRACT

The named invention, Imajector, is an invention that will enable a user of an electronic device to simply project images (still or in motion) via built-in and/or inserted diminutive projector in a digital camera, digital camcorder, laptop computer, and cellular telephone. The purpose of this invention is to eliminate the conventional bulky projectors for those users that want the convenience of having an all-in-one electronic component. By simply clicking on a button on the electronic device, a user can project the images onto a flat surface. The Imajector invention is the built-in and/or miniaturized projector that will be inserted in an electronic device such as a digital camera, digital camcorder, laptop computer, and cellular phone.

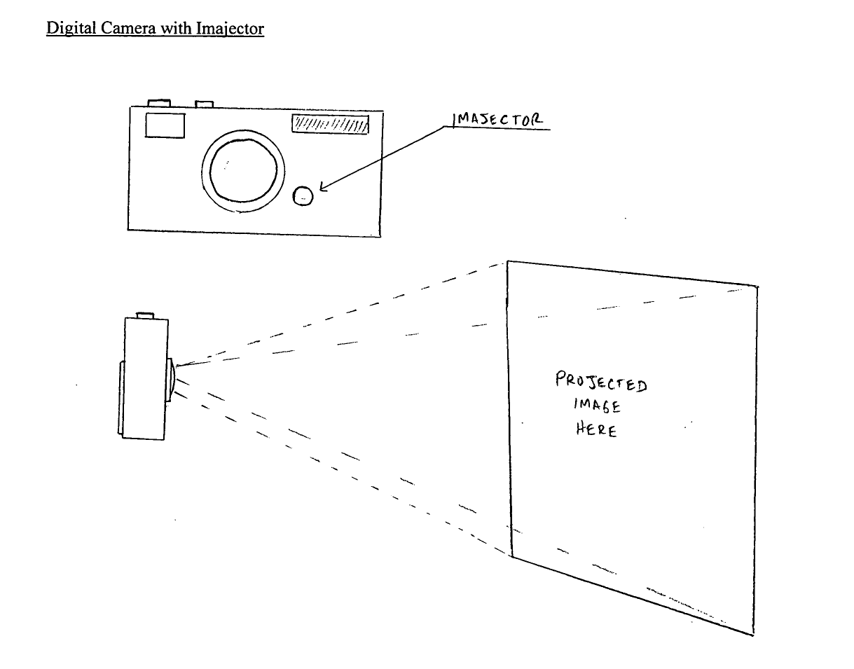

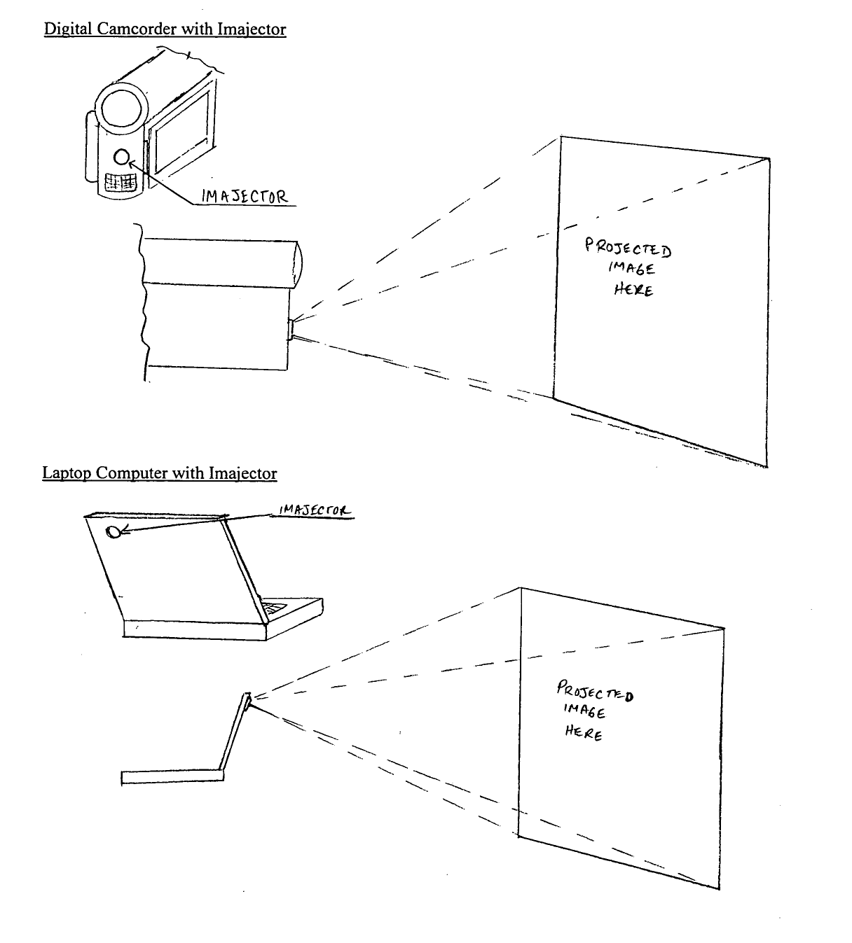

### DESCRIPTION OF THE INVENTION

Although conventional stand-alone projectors have already been invented, I am the inventor of the Imajector idea, also known as Ima-jector, which is a miniaturized projector implanted in an electronic device. The invention is titled “Imajector” or “Ima-jector” which will allow users to conveniently project the images taken of a digital camera, a digital camcorder, laptop, or any electronic device onto most surfaces for viewing purposes via inserted diminutive projector in a digital camera, digital camcorder, laptop computer, and cellular phone. By projecting the images through the Imajector, which is a built-in miniature projector featured in the above stated electronic devices, the user will enjoy the convenience of quick or lengthen previewing with all audiences without having to view the images on the small LCD screens of digital cameras and camcorders or any electronic devices, and instead of having to view it on a regular television, large computer monitor, or a regular sized projector screen. The miniature projector feature implanted in a digital camera or camcorder or any electronic devices will result in the best possible resolution when it is projected onto a surface that is light in color, i.e. white, little gray, etc., but the light projection can be viewed on most flat surface regardless of color or texture. The images are best viewed with greater resolution and brightness if projected onto a flat vertical surface that is between 3 to 10 feet away with minimum direct sunlight. The size of the projected images can vary and can be increased or decreased by simply moving the camera or electronic device away from the vertical or horizontal surface or towards the surface or by adjusting the lens on the Imajector. The projector in the camera or camcorder will use high-powered small lights that will use minimal battery power. This added feature in a camera or camcorder or electronic device will slightly increase the actual size and weight but will definitely increase the convenience and enjoyment of the gadgets. The projector can be activated by simply pushing a button built-in on the camera or any electronic device to view the images instantly. These images can be viewed individually or slide show from the digital camera or in a digital camcorder, image can be viewed in still or in motion, depending on how the images were taken.

For the laptop computer with the built-in Imajector, this will be very useful and highly convenient for the user who does presentations or users that prefer seeing the images onto a larger picture to several audiences at remote locations where standard projectors are not available. This will eliminate the need for expensive standard bulky projectors. The Imajector in the laptop/notebook computer can also be used as an alternative to the laptop's LCD screen and can be used simultaneously with the LCD and Imajector turned on or just the Imajector turned on alone. The Imajector in the laptop computer will contain a high-powered small light(s) to project the images onto most surfaces. Since most of the image projections on laptops will mainly be used for presentations or an alternative viewing screen on a wall or any surface, a small high-powered magnifying glass will be needed to project the images with brighter and higher resolution for the larger audiences to see.

Over time, the Imajector will be improved on its size, power, look, specifications, weight, and shape.

1. What I claim as my invention is titled “IMAJECTOR”, also known as IMAC-JECTOR. The Imajector (Image Projector) is an idea of inserting or implementing a diminutive projector in an electronic device such as a digital camera, digital camcorder, laptop computer, and cellular telephone.
